(19) United States
(12) Patent Application Publication
(10) Pub. No.: US 2006/0077260 A1
(43) Pub. Date: Apr. 13, 2006

(54) Optical image stabilizer for camera lens assembly

(75) Inventors: Sun-Hyoung Pyo, Gyeonggi-do (KR); Doo-Sik Shin, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/104,701

(22) Filed: Apr. 13, 2005

(30) Foreign Application Priority Data
Oct. 12, 2004 (KR) 2004-81215

(51) Int. Cl. H04N 5/228

(52) U.S. Cl. 348/208.7

(57) ABSTRACT

An optical image stabilizer for a camera lens assembly is disclosed, wherein the stabilizer includes a housing; a board disposed movably in the housing, the board and the housing being spaced apart from each other; an image sensor disposed on the board for transforming image information inputted thereto into electric signals; a plurality of wire frames for supporting the board, wherein both ends of each wire frame are coupled to the housing and the board, respectively; and a driving unit for correcting the position of the image sensor by moving the board according to degrees of trembling of user's hands. The driving unit on which an image sensor is mounted is present substantially on the same surface as the board itself, thereby allowing the downsize of a camera lens assembly.

### CLAIM OF PRIORITY

This application claims priority to an application entitled “Optical Image Stabilizer for Camera Lens Assembly,” filed in the Korean Intellectual Property Office on Oct. 12, 2004 and assigned Serial No. 2004-81215, the contents of which are hereby incorporated by reference.

### BACKGROUND OF THE INVENTION

1. Field of the Invention

The present invention relates to a camera device, and more particularly to an optical image stabilizer for a camera lens assembly.

2. Description of the Related Art

As generally known in the art, there are two types of two-dimensional sensors, namely a CCD (Chare Coupled Device) sensor and a CMOS (Complementary Metal Oxide Semiconductor) sensor. These sensors are used for photographing dynamic and static images. CCD sensors provide excellent characteristics compared to CMOS sensors in terms of image quality. However, CCD sensors have disadvantages of high power consumption and complicated structures. Thus, CMOS image sensors have become increasingly popular in the market.

Recently, many attempts are made to improve the image quality of CMOS sensors. The image sensors have been improved as the use of digital cameras is gaining popularity. Now, it is common to find portable terminals such as cellular phones equipped with camera devices. When photographing moving images using such image sensors, unstable images are captured due to the trembling of cameras resulting from external causes, such as the user's trembling hands and mounting of cameras on vehicles. In order to solve the problem of unstable images, optical image stabilizers with a movement detector and a movement compensator have been introduced.

For the movement detector, a method of predicting movements of a device by a Gyro Sensor, etc., as well as a method of detecting a moved portion of an image at every frame by processing image signals are used. Thus, it is possible to solve the problem of unstable images and thus to obtain clear images based on the movement-related information detected using a refractive lens (active prism), which optionally refract the incident light, or controlling the input position of an image sensor.

FIG. 1 is a perspective view of a cameral lens assembly according to the prior art. As shown, the camera lens assembly includes an optical image stabilizer 100 for addressing unstable images by controlling the image input position of an image sensor 101. The optical image stabilizer 100 is provided with stages 102, 103 for driving the image sensor 101 in a first direction X and in a second direction Y, on the front surface and the rear surface of the image sensor 101, respectively, so that the input position of the image sensor 101 can be controlled.

The stages 102, 103 include a fixable stage 102 and a movable stage 103.

The fixable stage 102 is equipped with a pair of first guides 121 facing to each other at both sides thereof, both guides 121 extending in the first direction X in parallel to each other. The movable stage 103 is coupled to the first guides 121 in such a manner to allow a linear movement on the first guides 121, thereby reciprocating linearly in the first direction X.

The movable stage 103 is equipped with a pair of second guides 131 facing to each other at both sides thereof, both guides 131 extending in the second direction Y in parallel to each other. The second direction Y is perpendicular to the first direction X. The image sensor 101 is coupled to the second guides 131 in such a manner to allow a linear movement on the second guides 131, thereby reciprocating linearly in the second direction Y.

In operation, the movable stage 103 moves in the first direction X, the image sensor 101 also moves in the first direction X, and the image sensor 101 moves in the second direction Y on the movable stage 103 at the same time. Thus, the optical image stabilizer 100 has a structure including a pair of stages 102, 103 disposed at both surfaces of the image sensor 101, so that the image sensor 101 can be moved in two directions according to trembling of user's hands.

However, the conventional optical image stabilizer for a camera lens assembly as described above has two stages on both surfaces of an image sensor, thus hindering the camera lens assembly from being downsized. Therefore, it is difficult to mount a camera lens assembly on a product providing a space for mounting an additional component, such as a portable terminal.

### SUMMARY OF THE INVENTION

Accordingly, the present invention has been made to solve the above-mentioned problems occurring in the prior art and provides additional advantages, by providing an optical image stabilizer capable of downsizing of a product equipped with a camera lens assembly.

In accordance with an aspect of the present invention, there is provided an optical image stabilizer for a camera lens assembly which includes: a housing; a board disposed movably in the housing, the board and the housing being spaced apart from each other; an image sensor disposed on the board for transforming image information inputted thereto into electric signals; a plurality of wire frames for supporting the board, wherein both ends of each wire frame are coupled to the housing and the board, respectively; and a driving unit for correcting the position of the image sensor by moving the board according to the degrees of trembling of user's hands.

### BRIEF DESCRIPTION OF THE DRAWINGS

The above features and advantages of the present invention will be more apparent from the following detailed description taken in conjunction with the accompanying drawings, in which:

FIG. 1 is a perspective view showing a part of the cameral lens assembly according to the prior art;

FIG. 2 is a perspective view showing a camera lens assembly equipped with an optical image stabilizer according to an embodiment of the present invention;

FIG. 3 is a perspective view showing the optical image stabilizer included in the camera lens assembly shown in FIG. 2;

FIG. 4 is a front view showing the driving unit of the optical image stabilizer as shown in FIG. 3;

FIG. 5 is a lateral side view showing the driving unit of the optical image stabilizer as shown in FIG. 3;

FIG. 6 is a plan view showing the bottom surface of the board included in the optical image stabilizer as shown in FIG. 3; and

FIG. 7 is a schematic view illustrating the operation of the optical image stabilizer as shown in FIG. 3.

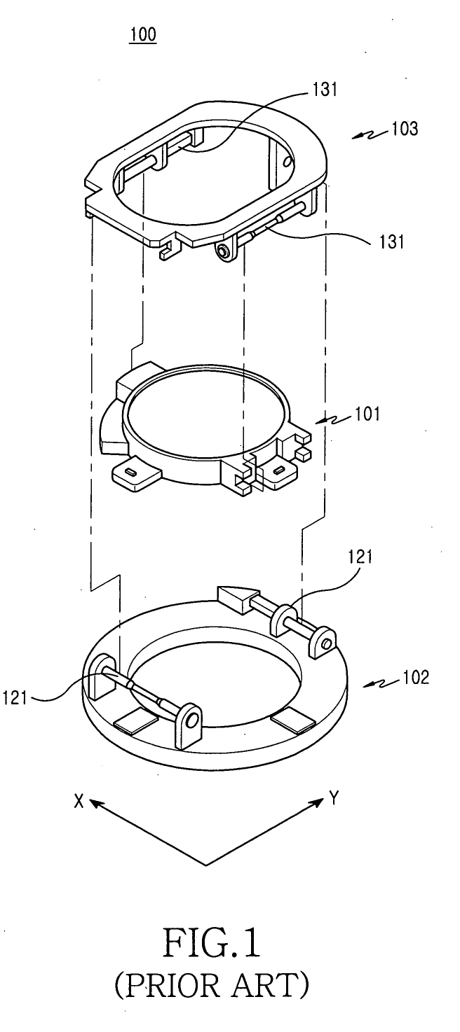

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

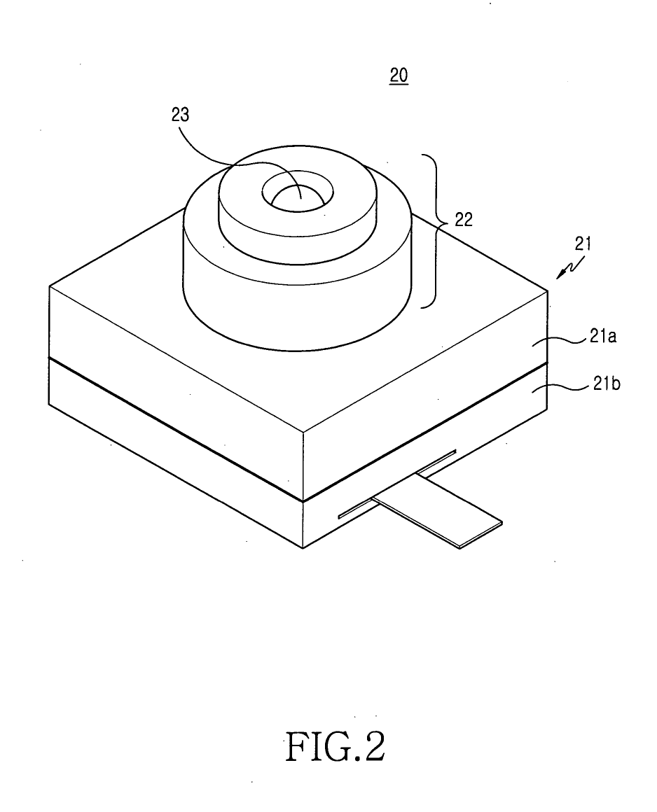

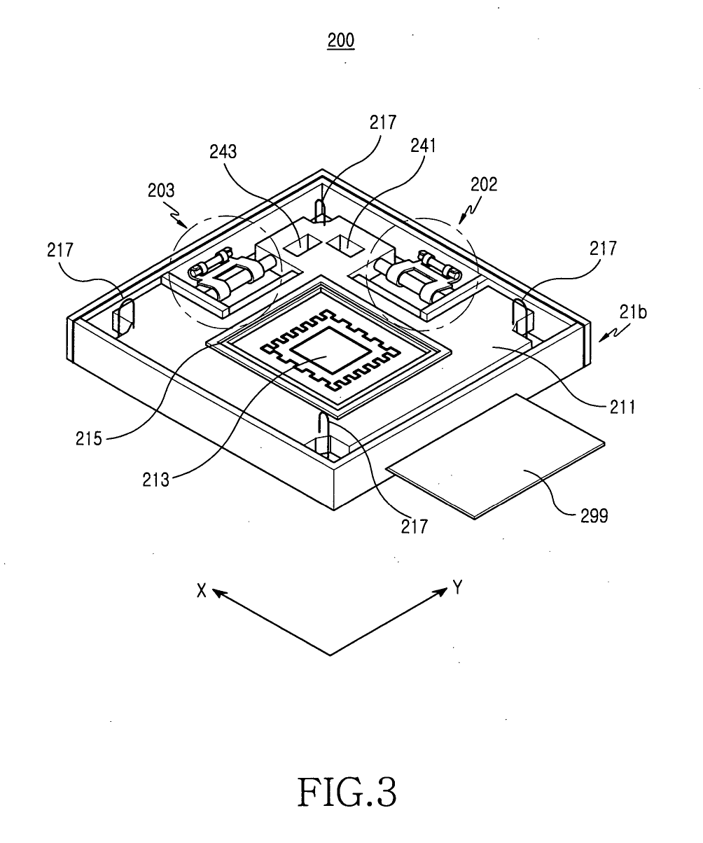

Referring to both FIGS. 2 and 3, the optical image stabilizer 200 of the camera lens assembly 20 is disposed in a housing 21. The optical image stabilizer 200 serves to correct the position of an image sensor 213 according to the trembling of user's hands. The camera lens assembly 20 has a housing 21 having an upper housing 21a and a lower housing 21b, and an optical tube 22 in which at least one lens (not shown) is contained. The optical tube 22 extends from the upper housing 21a and has an exposure window 23 on the terminal surface thereof. The optical image stabilizer 200 including the image sensor 213, etc., is contained in the housing 21.

The optical image stabilizer 200 of the camera lens assembly 20 is disposed in the lower housing 21b, and includes a board 211, image sensor 213, wire frames 217 and driving units 202, 203.

The board 211 is faced to the inner surface of the lower housing 21b, while being spaced apart therefrom. The board 211 is a flat panel and supported by the wire frames 217, so that it can move in a limited range in the lower housing 21b.

The image sensor 213 may be mounted directly on the board 211. Alternatively, the image sensor 213 may be disposed on an image sensor package 215 to form an integrated chip and then the chip is mounted on the board 211. The image sensor 213 is used for transforming image information inputted through the exposure window 23 into electric signals and may be a CCD or CMOS sensor.

The image sensor 213 may be coupled to main circuit devices of a camera or portable terminal through a flexible printed circuit 299 extending from the board 211.

Each wire frame 217 supports the board 211 in such a manner that both ends of the wire frame are fixed to the lower housing 21b and the board 211, respectively. The wire frame 217 is made of carbon steel wire and has a shape of alphabet letter “U”. Both ends of the wire frame 217 are fixed to the lower housing 21b and the board 211, respectively, by means of an epoxy adhesive. Multiple wire frames 217 support the board 211. It is preferable to use four wire frames supporting each corner of the board 211.

Although the wire frame 217 in the above-described embodiment is made of carbon steel and both ends of the wire frame are fixed to the lower housing 21b and the board 211, it is noted that materials and disposition of the wire frame 217 may be suitably selected as necessary by one skilled in the art. For example, the wire frame 217 may be formed of stainless steel, etc., and any one from both ends of the wire frame may be fixed to the upper housing 21a or the optical tube 22 in the camera lens assembly 20.

The driving units 202, 203 correct the position of the image sensor 213 by moving the board 211 according to the degrees of trembling of user's hands.

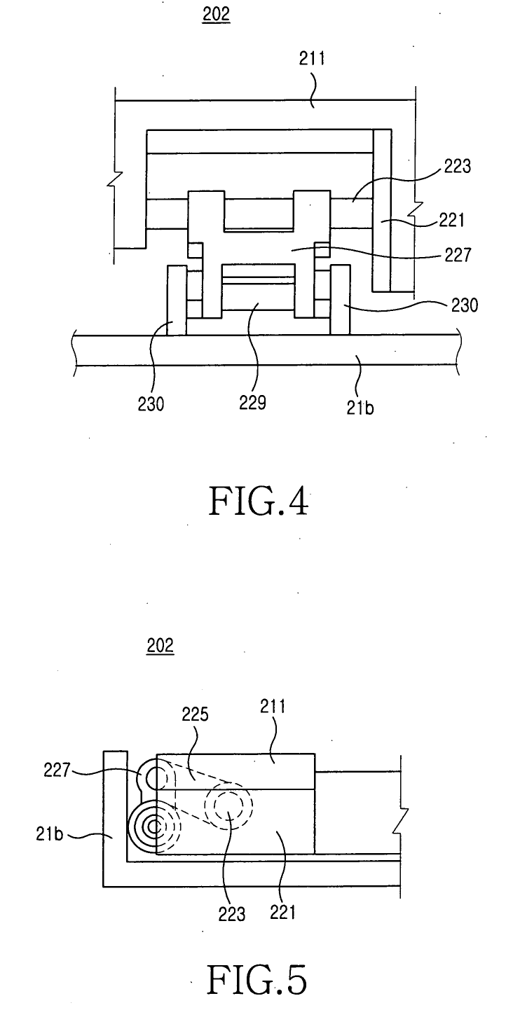

Referring to FIGS. 4 and 5, the driving units 202, 203 include a first driving unit 202 for moving the board 211 in a first direction X and a second driving unit 203 for moving the board 211 in a second direction Y The first and the second driving units 202, 203 have the same structure but different only in the moving direction. The first direction X refers to the direction extending in parallel with one surface of the board 211, and the second direction Y refers to the direction perpendicular to the first direction X as well as extending in parallel with one surface of the board 211.

Each of the first and the second driving units 202, 203 includes a driving element 221, a first and a second supports 223, 229, and a first and a second links 225, 227. As the first and the second driving units 202, 203 have the same structure, reference will now be made in detail only to the structure and operation of the first driving unit 202 to save redundancy.

In operation, the driving element 221 vibrates according to the degrees of trembling of user's hands and may be made of an ultrasonic motor, piezoelectric element, step motor, etc. The driving element 221 is attached to the board 211 to generate driving power for moving the board 211. Thus, when the driving element 221 of the first driving unit 202 operates, the board 211 moves in the first direction X. Similarly, when the driving element of the second driving unit 203 operates, the board 211 moves in the second direction Y.

The first support 223 is disposed in such a manner that it can move linearly on the board 211 in the direction horizontal to the board 211 according to the vibration of the driving element 221. The first support 223 extends from the driving element 221 in the first direction X. Thus, the board 211 and the first support 223 reciprocate relative to each other as well as linearly along the first direction X, while the first support 223 guiding the linear reciprocation of the board 211.

The second support 229 is fixed on the lower housing 21b. A pair of supporting ribs 230 facing to each other as well as extending in the inner surface of the lower housing 21b, support both ends of the second support 229.

The first link 225 is coupled rotatably to the first support 223 at one end thereof and remaining end of the first link 225 is coupled rotatably to one end of the second link 227, while remaining end of the second link 227 is coupled rotatably to the second support 229.

As the first link 225 and the second link 227 couple the first support 223 with the second support 229, the board 211 can move in the direction perpendicular to the first direction X. In other words, the board 211 can move horizontally in the second direction Y Accordingly, the first and the second links 225, 227 of the first driving unit 202 facilitate the horizontal movement of the board 211 in the second direction Y.

Hereinafter, motion of the board 211 according to the motion of the driving units 202, 203 will be explained in detail.

First, when the driving element 221 of the first driving unit 202 vibrates, the board 211 moves in the first direction X. Particularly, when the driving element 221 of the first driving unit 202 vibrates, the board 211 moves relative to the first support 223 as well as horizontally along the first direction X. More particularly, the first support 223 of the first driving unit 202 guides the horizontal movement of the board 211 in the first direction X. Meanwhile, the first and the second links 225, 227 of the second driving unit 203 rotate so as to come close to each other or to be away from each other, according to the horizontal movement of the board 211 in the first direction X, thereby facilitating the horizontal movement of the board 211 in the first direction X.

Similarly, when the driving element 221 of the second driving unit 203 vibrates, the board 211 moves in the second direction Y according to the occurrence of linear reciprocation of the board 211, relative to the first support 223 of the second driving unit 203. Particularly, rotation of the first and the second links 225, 227 of the first driving unit 202 facilitate the horizontal movement of the board 211 in the second direction Y.

The optical image stabilizer 200 further includes units for detecting a relative change in position of the board 211.

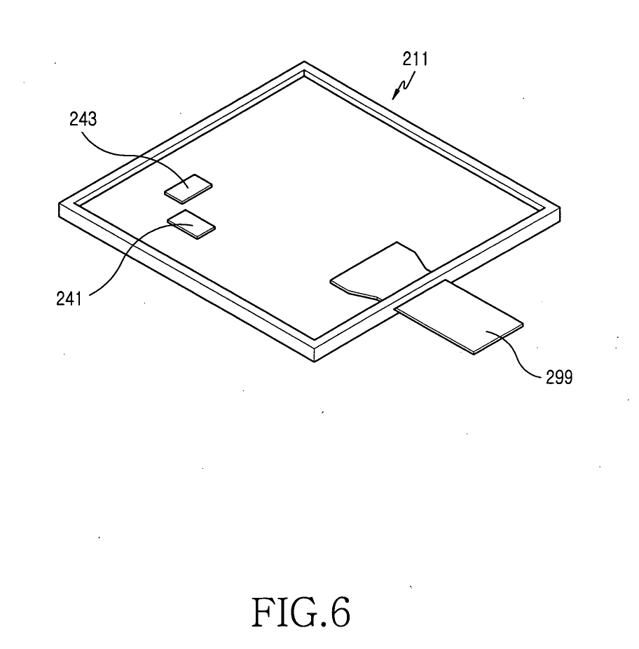

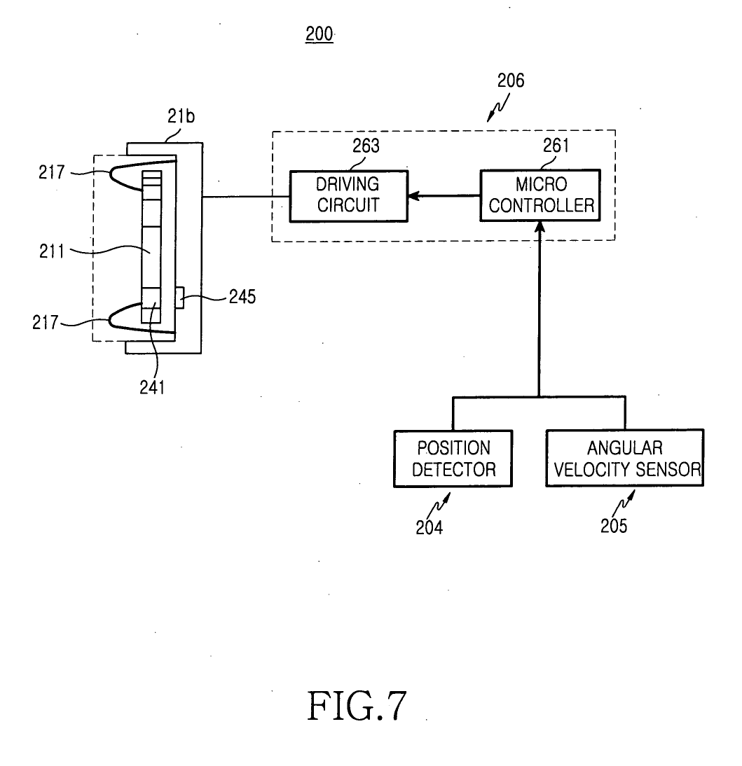

Referring to FIGS. 6 and 7, the optical image stabilizer 200 includes an angular velocity sensor 205 for detecting the trembling of user's hands, and a position detector 204 for detecting a relative change in position of the board 211.

The angular velocity sensor 205 is disposed in the housing 21 or a camera body to detect trembling of user's hands.

The position detector 204 including light emitting diodes 241, 243 and a photo diode 245 is disposed on the board 211 and on the lower housing 21b to detect a relative change in position of the board 211. A pair of light emitting diodes 241, 243 is attached on the bottom surface of the board 211 so as to be faced to the inner surface of the lower housing 21b. The photodiode 245 is attached on the inner surface of the lower housing 21b in a position corresponding to the light emitting diodes 241, 243. Particularly, the light emitted from the light emitting diodes 241, 243 can be detected by the photo diode 245. More particularly, when the board 211 moves horizontally along the first direction X or the second direction Y, it is possible to detect a relative change in position of the board 211 according to the amount of light detected by the photo diode 245.

The data including the degree of trembling detected from the angular velocity sensor 205 and the position detector 204 and a relative change in position of the board 211 are supplied to a controller 206,then used in generating signals for operating the driving units 202, 203. Particularly, once the data detected from the angular velocity sensor 205 and the position detector 204 are supplied to a micro controller 261, the micro controller 206 calculates how much the board 211 should be moved based on the data detected from the angular velocity sensor 205 and the position detector 204, and supplies the calculated value to a driving circuit 263 for driving the driving units 202, 203 so that the driving units 202, 203 can be operated.

As described above, in the optical image stabilizer for a camera lens assembly according to the present invention, the driving unit for driving the board, on which an image sensor is mounted, is present substantially on the same surface as the board itself. Therefore, the optical image stabilizer can downsize a camera lens assembly. Additionally, because such downsized camera lens assemblies are mounted on cameras or portable terminals with ease, it is possible to realize various designs of cameras or portable terminals. Further, the camera lens assemblies having such a simple structure can improve the reliability of products such as cameras or portable terminals.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An optical image stabilizer for a camera lens assembly, comprising:
a housing;
a board movably disposed in the housing;
an image sensor disposed on the board for transforming image information inputted thereto into electric signals;
a plurality of wire frames for supporting the board, wherein both ends of each wire frame are coupled to the housing and the board, respectively; and
a driving unit for correcting the position of the image sensor by moving the board according to degrees of trembling of user's hands.

2. The optical image stabilizer as claimed in claim 1, wherein the wire frames support four sites of the board and each wire frame has U shape.

3. The optical image stabilizer as claimed in claim 1, wherein the wire frame is formed of carbon steel materials.

4. The optical image stabilizer as claimed in claim 1, wherein both ends of the wire frame are fixed to the housing and to the board, respectively, by means of an epoxy adhesive.

5. The optical image stabilizer as claimed in claim 1, wherein the driving unit includes:
a first driving unit for reciprocating the board linearly in a first direction relative to the housing; and
a second driving unit for reciprocating the board linearly in a second direction relative to the housing.

6. The optical image stabilizer as claimed in claim 5, wherein the board has a flat planar shape, the first direction extends horizontally to one surface of the board, and the second direction extends perpendicularly to the first direction and extends horizontally to one surface of the board.

7. The optical image stabilizer as claimed in claim 5, wherein each of the first and the second driving units includes:
a driving element attached on the board;
a first support extending from the driving element and reciprocating linearly on the board in the direction horizontal to the board;
a second support disposed on the housing in parallel to the first support;
a first link rotatably coupled to the first support; and
a second link rotatably coupled to the first link at one end thereof and rotatably coupled to the second support at the other end thereof.

8. The optical image stabilizer as claimed in claim 5, further including:
an angular velocity sensor disposed on a camera equipped with the camera lens assembly for measuring a change in angular velocity in each of the first direction and the second direction and for detecting the degrees of trembling of user's hand;
a position detector for detecting a position of the board relative to the housing, the position detector including a photo diode disposed on the housing and a light emitting diode disposed on the board in a position corresponding to the photo diode; and
a controller for operating the driving unit according to the degrees of trembling of user's hands detected from the angular velocity sensor and the position of the board relative to the housing detected from the position detector.

9. The optical image stabilizer as claimed in claim 7, wherein the driving element is a ultrasonic motor.

10. The optical image stabilizer as claimed in claim 7, wherein the driving element is a piezoelectric element.

11. The optical image stabilizer as claimed in claim 7, wherein the driving element is a step motor.
